(19) United States
(12) Patent Application Publication
(10) Pub. No.: US 2026/0326222 A1
(43) Pub. Date: Oct. 22, 2026

(54) BAR BLADE FOR MANUFACTURING A BEVEL GEARING

(71) Applicant: Klingelnberg GmbH, Hückeswagen (DE)

(72) Inventors: Stefan Herzhoff, Hückeswagen (DE); Karl- Martin Ribbeck, Remscheid (DE); Dieter Reuner, Wipperfürth (DE)

(21) Appl. No.: 19/645,891

(22) Filed: Apr. 13, 2026

(30) Foreign Application Priority Data
Apr. 16, 2025 (EP) 25170984.6

(51) Int. Cl. B23F 21/22; B23F 21/18

(52) U.S. Cl. CPC B23F 21/226; B23F 21/186

(57) ABSTRACT

Bar blade for manufacturing a bevel gearing, having a rake face (4), a flank face (6), a ground rake face facet (8), a ground flank face facet (10), and a cutting edge (12), wherein the rake face (4) adjoins the rake face facet (8) and the rake face facet (8) is inclined relative to the rake face (4), wherein the flank face (6) adjoins the flank face facet (10) and wherein a rake face chamfer (14) is provided which adjoins the rake face facet (8) with a first side (16) and defines the cutting edge (12) on a second side (18) facing away from the rake face facet (8).

### CROSS-REFERENCE TO RELATED APPLICATIONS

This application claims the benefit of European patent application no. 25170984.6, filed on 16 Apr. 2025, the disclosure of which is incorporated herein by reference in its entirety.

### TECHNICAL FIELD

The present disclosure relates to a bar blade for manufacturing a bevel gearing, having a rake face, a flank face, a ground rake face facet, a ground flank face facet, and a cutting edge, wherein the rake face adjoins the rake face facet and wherein the flank face adjoins the flank face facet. The disclosure also relates to a cutter head for producing a bevel gearing, a method for producing a bevel gearing, and a method for grinding a bar blade.

### BACKGROUND

Bar blades are used for the soft machining of bevel gear blanks with a geometrically defined cutting edge. The bar blades are usually inserted into a cutter head for this purpose and are used for continuous or single-piece bevel gear cutting.

Document DE 103 24 432 B4 shows a method for manufacturing a profile-sharpened bar blade for manufacturing bevel and hypoid gears, in which the grinding process for manufacturing the bar blade is simplified. According to DE 103 24 432 B4, this is achieved by providing the flank face and/or rake face of the bar blade with a facet that has the same angle as the associated flank face and/or rake face. In this case, the bar blade is not repositioned after grinding the flank face and/or the rake face, but the facet is ground directly at the same angle.

Investigations by the applicant using the bar blades known from DE 103 24 432 B4 have shown that, depending on the geometry, process, and wear condition of the grinding wheel used to grind the bar blades, a more or less significant chipping of the blade or cutting edge produced on the bar blade occurs. This promotes breakouts of the blade or cutting edge and reduces the service life.

When bar blades are used for the machining of bevel gearings, L- to U-shaped multi-flank chips are produced, which take up a lot of space in the tooth gap and, in unfavorable cases, lead to scratches and chip welding on the tooth flanks. In addition, the L- to U-shaped multi-flank chips place high mechanical and thermal loads on the bar blades, causing them to wear out quickly.

Against this background, the disclosure is based on the technical problem of providing an improved bar blade. Furthermore, a cutter head for producing bevel gearing, a method for producing bevel gearing, and a method for grinding a bar blade are to be specified.

The technical problem described above is solved in each case by the features of the independent claims. Further designs of the disclosure are apparent from the dependent claims and the following description.

### SUMMARY

According to a first aspect, the disclosure relates to a bar blade for producing a bevel gearing, having a rake face, a flank face, a ground rake face facet, a ground flank face facet, and a cutting edge, wherein the rake face adjoins the rake face facet and wherein the flank face adjoins the flank face facet. The bar blade is characterized in that a rake face chamfer is provided, which adjoins the rake face facet with a first side and defines the cutting edge on a second side facing away from the rake face facet, and/or that a flank face chamfer is provided, which adjoins the flank face facet with a first side and defines the cutting edge on a second side facing away from the flank face facet.

The additional rake face chamfer and/or the additional flank face chamfer have the advantage that, when grinding the bar blade, there is less chipping of the cutting edge and, as a result, a more stable cutting edge with better cutting performance is produced. The additional rake face chamfer and/or the additional flank face chamfer can serve as chip breakers to prevent the formation of large multi-flank chips or to divide them into several individual chips during the machining of the bevel gear. This prevents scratches on the tooth flanks of the bevel gear to be manufactured and reduces the load on the bar blade in question.

The rake face and the rake face facet may be separated from each other by a non-tangential discontinuity, such as an edge, a step, or the like, or may meet at this non-tangential discontinuity.

The rake face facet and the rake face chamfer may be separated from each other by a non-tangential discontinuity, such as an edge, a step, or the like, or may meet at this non-tangential discontinuity.

The flank face and the flank face facet may be separated from each other by a non-tangent-continuous discontinuity, such as an edge, a step, or the like, or may meet at this non-tangent-continuous discontinuity.

The flank face facet and the flank face chamfer may be separated from each other by a non-tangential discontinuity, such as an edge, a step, or the like, or may meet at this non-tangential discontinuity.

The bar blade can essentially consist of a hard metal or high-speed steel, wherein the bar blade can be coated with a wear protection coating. Coatings can be produced using CVD or PVD processes, for example. The coatings may comprise, for example, titanium nitride (TiN), titanium aluminum nitride (TiAlN), chromium nitride (CrN), titanium carbonitride (TiCN) or the like.

The blade may have a cutting edge rounding, e.g., in the head area and/or in the area of the main blade and/or in the area of the secondary blade. The principle of cutting edge rounding is known in the prior art.

It may be provided that the rake face chamfer, as viewed in a direction perpendicular to the blade, has a smaller width than the rake face facet, at least in sections, and/or the rake face chamfer has a width of more than 50 micrometers and less than 200 micrometers, and/or the rake face chamfer has a non-constant width when viewed along the blade. The width of the rake face chamfer can therefore be adapted in particular to the respective gear cutting process or the chip thicknesses and chip geometries produced during gear cutting in such a way that the rake face chamfer can serve, for example, as a chip breaker.

According to one design of the bar blade, it may be provided that the flank face chamfer, as viewed in a direction perpendicular to the cutting edge, has a smaller width than the flank face facet, at least in sections, and/or the flank face chamfer has a width of more than 50 micrometers and less than 200 micrometers, and/or the flank face chamfer has a non-constant width along the cutting edge.

It may be provided that an inclination of the rake face chamfer relative to the rake face is defined by a relative rake face chamfer inclination angle, wherein the rake face chamfer inclination angle has a value selected from a range greater than or equal to 10° and less than or equal to 30°, and/or wherein the rake face chamfer inclination angle, as viewed along the cutting edge, is not constant. The angle of the rake face chamfer can therefore be adapted in particular to the respective gear cutting process or the chip thicknesses and chip geometries resulting during gear cutting in such a way that the rake face chamfer can serve, for example, as a chip breaker.

According to one design of the bar blade, it may be provided that an inclination of the flank face chamfer relative to the flank face is defined by a relative flank face chamfer inclination angle, wherein the flank face chamfer inclination angle has a value selected from a range greater than or equal to 10° and less than or equal to 30° and/or wherein the flank face angle, as viewed along the cutting edge, is not constant.

It may be provided that the rake face chamfer, as viewed in cross-section, is straight at least in sections.

Alternatively or additionally, it may be provided that the rake face chamfer, as viewed in cross-section, is concave at least in sections.

Alternatively or additionally, it may be provided that the flank face chamfer, as viewed in cross-section, is straight at least in sections.

Alternatively or additionally, it may be provided that the flank face chamfer, as viewed in cross-section, is concave at least in sections.

According to a design of the bar blade, it may be provided that the rake face facet is straight, at least in sections, when viewed in cross-section.

Alternatively or additionally, it may be provided that the rake face facet, as viewed in cross-section, is concave at least in sections.

Alternatively or additionally, it may be provided that the flank face facet, as viewed in cross-section, is straight at least in sections.

Alternatively or additionally, it may be provided that the flank face facet, as viewed in cross-section, is concave at least in sections.

Angles are usually defined, for example, between two inclined, flat surfaces in order to describe the relative orientation of these surfaces to each other. In the present case, however, the rake face chamfer inclination angle and/or flank face chamfer inclination angle can also be used to describe the relative orientation of the rake face chamfer to the rake face or the flank face chamfer to the flank face in the case where the flank face chamfer or the rake face chamfer is designed in a concave manner. This is because the curvature of the concave rake face chamfer or the flank face chamfer is so small in practice that the rake face chamfer or the flank face chamfer appear essentially straight when viewed in cross-section. Thus, as viewed in cross-section, an auxiliary plane can be placed through the lateral ends of the rake face chamfer or the flank face chamfer in order to measure the rake face chamfer inclination angle and/or the flank face chamfer inclination angle.

According to a second aspect, the disclosure relates to a cutter head for manufacturing bevel gearing, having a base body that has a plurality of blade shafts, having a plurality of bar blades, wherein each of the bar blades is seated in an associated blade shaft. The cutter head is characterized in that the bar blades are designed according to one of the preceding claims.

According to a third aspect, the disclosure relates to a method for producing a bevel gearing by machining the bevel gearing, using a cutter head according to the disclosure.

According to a fourth aspect, the disclosure relates to a method for grinding a bar blade, comprising the following method steps: grinding a rake face of the bar blade; grinding a flank face of the bar blade; grinding a rake face facet of the bar blade; grinding a flank face facet of the bar blade, wherein the rake face adjoins the rake face facet and wherein the flank face adjoins the flank face facet. The method is characterized by grinding a rake face chamfer which adjoins the rake face facet on a first side and which defines the cutting edge on a second side facing away from the rake face facet, and/or by grinding a flank face chamfer which adjoins the flank face facet on a first side and which defines the cutting on a second side facing away from the flank face facet.

### BRIEF DESCRIPTION OF THE DRAWINGS

The disclosure is described in more detail below with reference to drawings. Each of the following shows schematically:

FIG. 1 shows a section of a bar blade according to the disclosure in a perspective view from above;

FIG. 2 shows the bar blade from FIG. 1 in a partial sectional view according to section II–II from FIG. 1;

FIG. 3 shows a section of a second bar blade according to the disclosure in a perspective view from above;

FIG. 4 shows the bar blade from FIG. 4 in three partial sectional views according to section IV.1 – IV.1, section IV.2 – IV.2, and section IV.3 – IV.3 from FIG. 3;

FIG. 5 shows a section of a third bar blade according to the disclosure in a perspective view from above;

FIG. 6 shows the bar blade from FIG. 5 in a partial sectional view according to section VI – VI from FIG. 5;

FIG. 7 shows a section of a fourth bar blade according to the disclosure in a perspective view from above;

FIG. 8 shows the bar blade from FIG. 7 in an enlarged view;

FIG. 9 shows a cutter head;

FIG. 10 shows a bevel gear;

FIG. 11 shows a method step; and

FIG. 12 shows method steps.

### DETAILED DESCRIPTION OF THE DRAWINGS

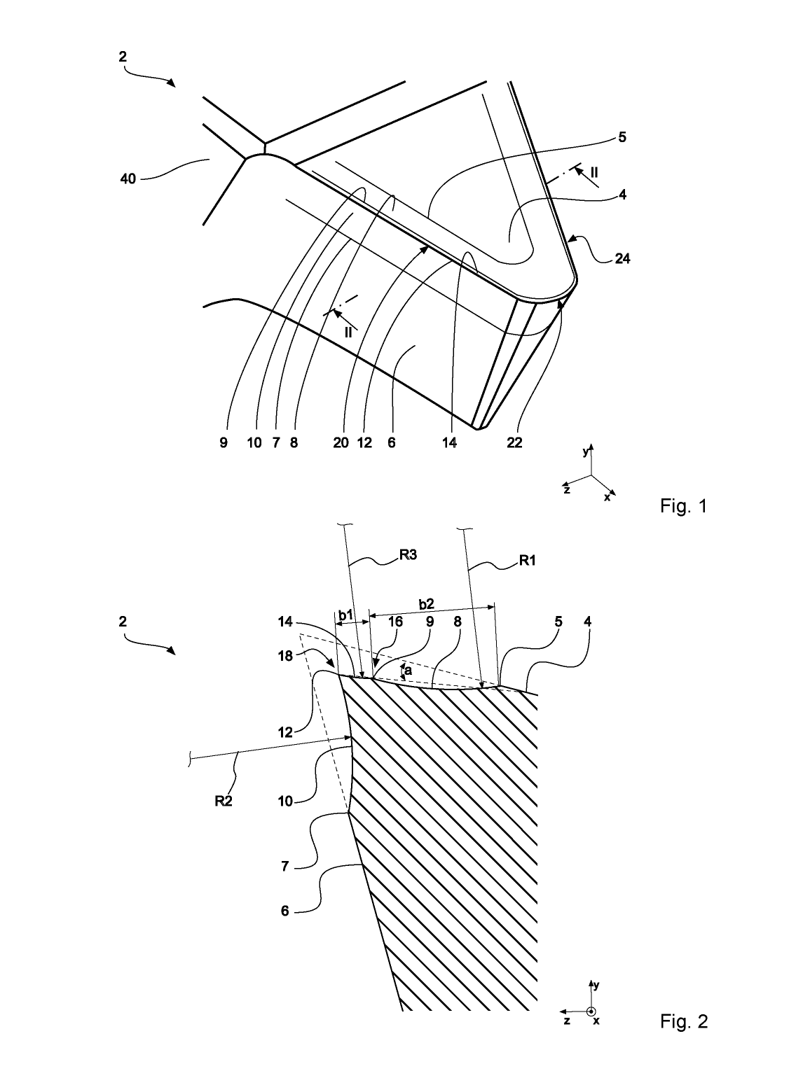

FIG. 1 shows a section of a bar blade 2 according to the disclosure for manufacturing a bevel gearing. For better comprehensibility of the following explanations, a Cartesian coordinate system x, y, z is introduced. The intersection line II – II shown in FIG. 1 is located in a plane of intersection that is oriented parallel to a plane spanned by the coordinate axes y and z, with the x-axis perpendicular to this plane of intersection (see FIG. 2).

All dimensions, radii, and proportions shown in the figures are merely examples and are greatly exaggerated in order to make the individual areas and sections of the bar blade, and in particular the chamfers according to the disclosure, visible.

The bar blade 2 has a rake face 4. The bar blade 2 has a flank face 6. The bar blade 2 has a ground rake face facet 8. The rake face 4 and the flank face 6 are also ground. The bar blade 2 has a ground flank face facet 10. The bar blade 2 has a cutting edge 12.

The rake face 4 adjoins the rake face facet 8. The rake face 4 and the rake face facet 8 converge at a first edge 5, wherein the first edge 5 forms a defined boundary between the rake face 4 and the rake face facet 8.

The flank face 6 adjoins the flank face facet 10. The flank face 6 and the flank face facet 10 converge at a second edge 7, wherein the second edge 7 forms a defined boundary between the flank face 6 and the flank face facet 10.

In addition to the rake face facet 8, a ground rake face chamfer 14 is provided on the bar blade 2. The rake face chamfer 14 adjoins the rake face facet 8 with a first side 16. The rake face chamfer 14 defines the cutting edge 12 on a second side 18 facing away from the rake face facet 8.

The rake face facet 8 and the rake face chamfer 14 converge in a third edge 9, wherein the third edge 9 forms a defined boundary between the rake face facet 8 and the rake face chamfer 14.

As viewed in a direction perpendicular to the cutting edge 12, the rake face chamfer 14 has a smaller width b1 than the rake face facet 8, whose width b2 measured in this direction is more than three times the width b1 of the rake face chamfer 14.

The width b1 of the rake face chamfer 14 is approximately 100 micrometers.

An inclination of the rake face chamfer 14 relative to the rake face 4 is defined by a relative rake face chamfer inclination angle a1. The rake face chamfer inclination angle a1 is 20° in the present case. The rake face chamfer inclination angle a1 is measured relative to an imaginary extension of the rake face 4 and a plane passing through the ends of the rake face chamfer 14, as shown in FIG. 2.

The rake face facet 8 is concave when viewed in cross-section and is defined by a radius R1.

The flank face facet 10 is concave when viewed in cross-section and is defined by a radius R2.

The rake face chamfer 14 is concave when viewed in cross-section and is defined by a radius R3. The radius R3 is so large in relation to the width b1 that the rake face chamfer 14 appears straight in cross-section. According to alternative designs, the rake face facet 14 may be straight when viewed in cross-section.

As shown in FIG. 1, the rake face chamfer 14 extends along a main cutting edge 20, along a head cutting edge 22, and along a secondary cutting edge 24 of the bar blade 2.

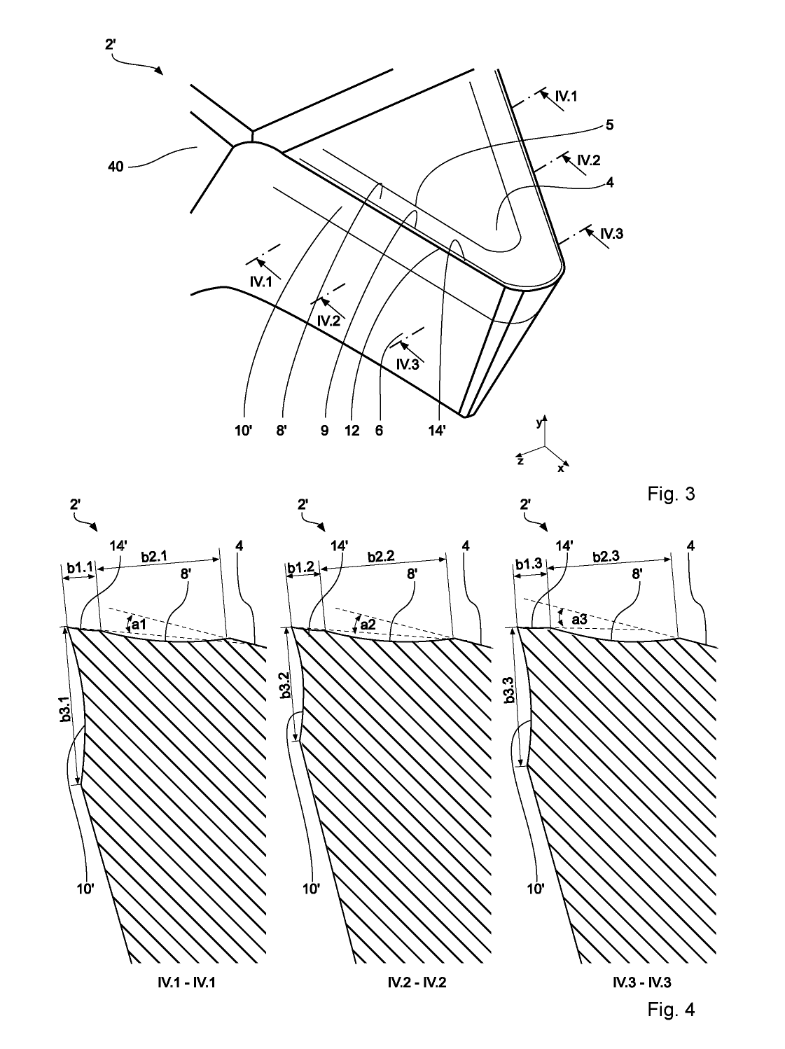

FIGS. 3 and 4 show a second bar blade 2' according to the disclosure. To avoid repetition, only the differences from the exemplary embodiment described above are discussed below, with the same reference signs being assigned to the same features.

The bar blade 2' differs from the bar blade 2 in that the bar blade 2' has a rake face chamfer 14' whose width and angle change along the cutting edge 12. This is shown exemplarily and schematically by means of the partial sectional views according to section IV.1 – IV.1, section IV.2 – IV.2, and section IV.3 – IV.3, which are shown in partial sectional views according to FIG. 4 analogous to FIG. 2.

The relative angles a1, a2, a3 satisfy the condition that a1 < a2 < a3. The angle a1 is therefore smaller than the angle a2, and the angle a2 is smaller than the angle a3.

Furthermore, it applies that the width b1.1 is greater than the width b1.2, and the width b1.2 is greater than the width 1.3. Furthermore, the widths b2.1, b2.2, and b2.3 of the rake face facet 8' vary along the cutting edge 12. The dimensions and relations of the widths and angles are to be understood as examples and schematics and are only intended to illustrate that the geometry of the rake face facet 14' can vary along the cutting edge. This applies equally to the geometry of the rake face facet 8' of the bar blade 2'.

Furthermore, the flank face facet 10' may also have a varying width when viewed along the cutting edge 12, as shown exemplarily for the widths b3.1, b3.2, and b3.3.

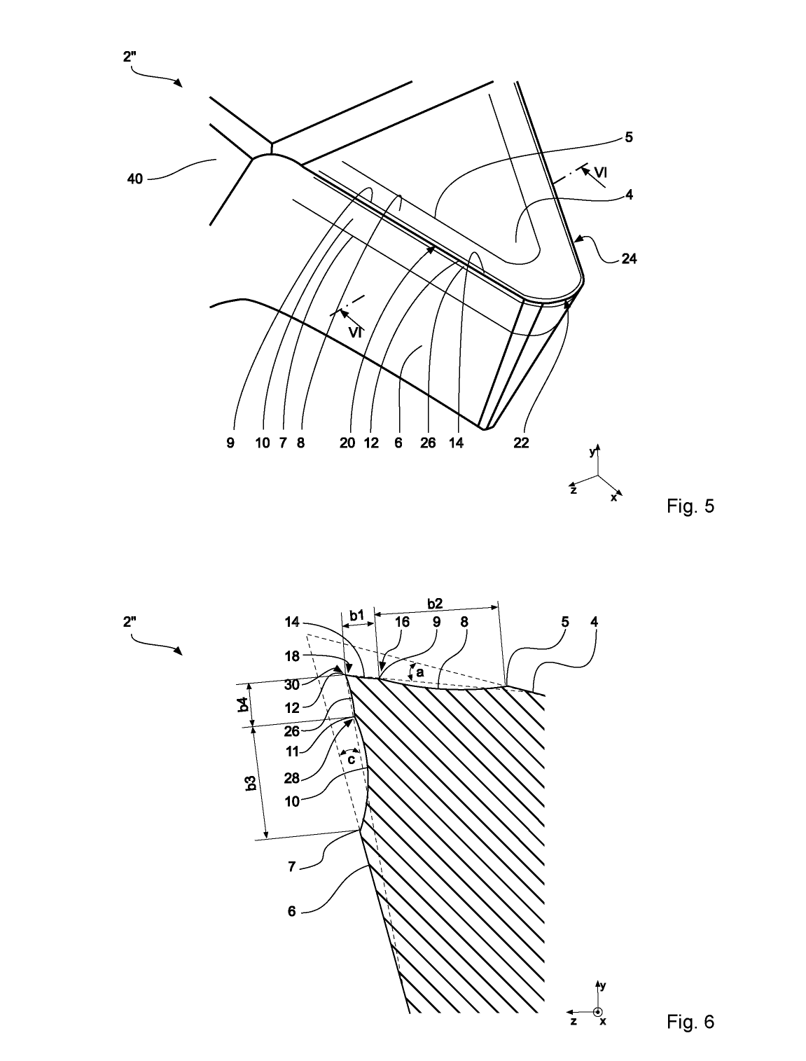

FIGS. 5 and 6 show a third bar blade 2'' according to the disclosure. To avoid repetition, only the differences from the first exemplary embodiment are discussed, with the same reference signs being assigned to the same features.

The bar blade 2'' differs from the bar blade 2 in that the bar blade 2'' has a flank face chamfer 26.

The flank face chamfer 26 adjoins the flank face facet 10 with a first side 28.

The flank face chamfer 26 defines the cutting edge 12 with a second side 30 facing away from the flank face facet 10.

The flank face chamfer 26 is inclined relative to the flank face 6 by a flank face chamfer inclination angle c.

The flank face chamfer 26 and flank face facet 10 converge in a fourth edge 11, wherein the fourth edge 11 forms a defined boundary between the flank face chamfer 26 and the flank face facet 10.

As viewed in a direction perpendicular to the cutting edge 12, the flank face chamfer 26 has a smaller width b4 than the flank face facet 10, whose width b3 is at least three times the width b4. The flank face chamfer 26 has a width b4 of more than 50 micrometers and less than 200 micrometers.

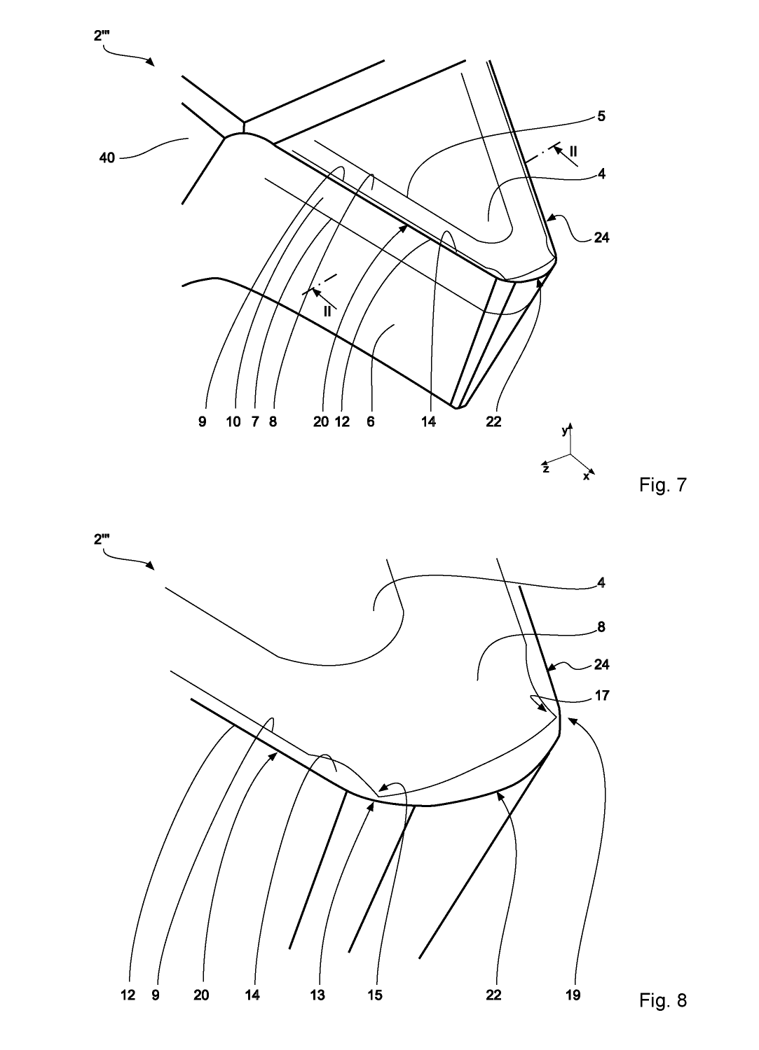

FIGS. 7 and 8 show a fourth bar blade 2''' according to the disclosure. To avoid repetition, only the differences from the first exemplary embodiment are discussed, wherein the same reference signs are assigned to the same features. FIG. 8 is an enlarged detail of FIG. 7.

The rake face chamfer 14 has a chip breaker 15 in a corner area 13 of the cutting edge 12, i.e., in a transition from the main cutting edge 20 to the head cutting edge 22, which is formed by a local change in the geometry of the rake face chamfer 14. The rake face chamfer 14 is thus first widened in the direction of the corner region 13 and then tapers off. The chip breaker 15 causes L- or U-shaped multi-flank chips to be torn open and/or prevented. Such a chip breaker 17 can also be formed in a corner area 19, i.e., a transition from the head cutting edge 22 to the secondary cutting edge 24.

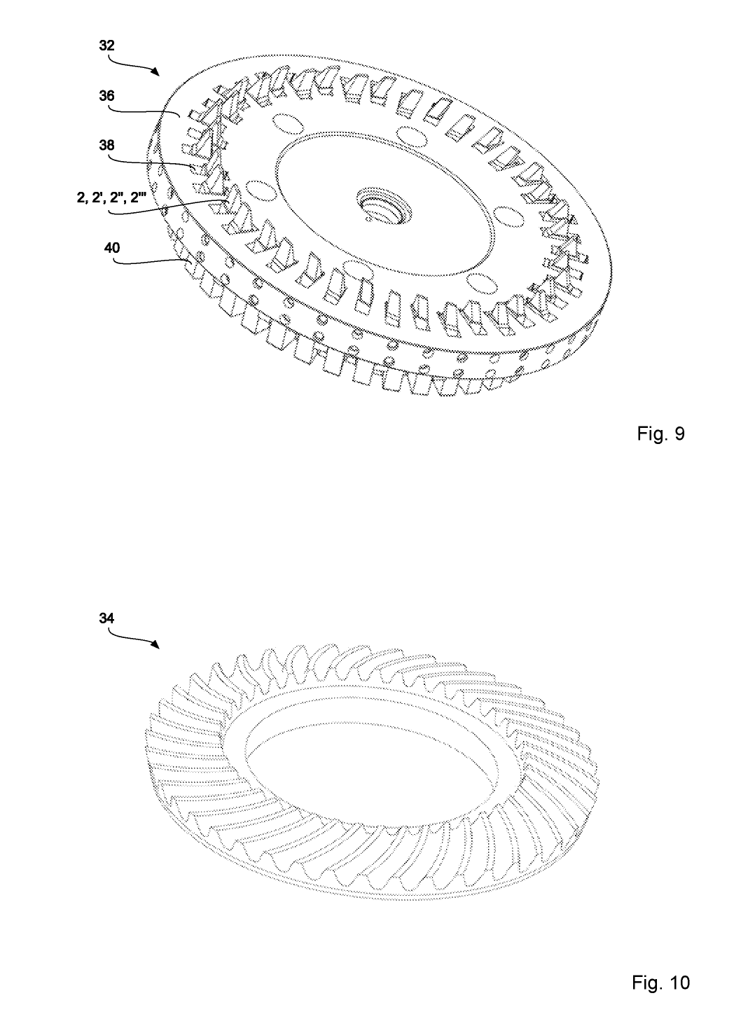

FIG. 9 shows a cutter head 32 for producing a bevel gearing 34 (FIG. 10).

The cutter head 32 according to FIG. 9 has a base body 36 which has a plurality of blade shafts 38. The blade shafts 38 are designed to accommodate bar blades, such as the bar blades 2, 2', 2", 2'" described in the disclosure.

Each of the bar blades 2, 2', 2'', 2'" is seated in an assigned blade shaft 36. A blade shaft 40 of a respective bar blade 2, 2', 2'', 2'" protrudes into the blade shaft 36 or, depending on its length, penetrates it, and is detachably clamped in the respective blade shaft 38, e.g., by means of a grub screw and/or a pressure piece.

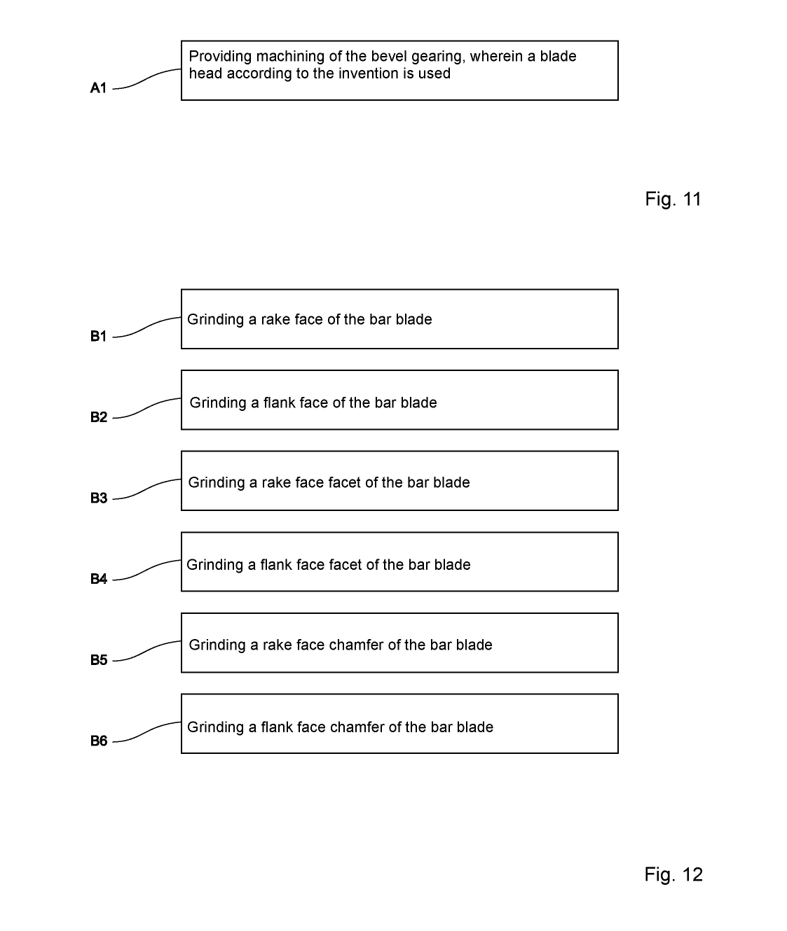

According to the disclosure, a method for manufacturing a bevel gearing by machining the bevel gearing can be specified, wherein a cutter head 32 according to the disclosure is used, as shown in FIG. 11 by method step A1.

According to the disclosure, a method for grinding a bar blade can be specified, comprising the following method steps, wherein the numbering does not specify a fixed order of the method steps (FIG. 12):
B1 Grinding a rake face of the bar blade;
B2 Grinding a flank face of the bar blade;
B3 Grinding a rake face facet of the bar blade, wherein the rake face adjoins the rake face facet;
B4 Grinding a flank face facet of the bar blade, wherein the flank face adjoins the flank face facet;
B5 Grinding a rake face chamfer which adjoins the rake face facet on a first side and defines the cutting edge on a second side facing away from the rake face facet; and/or
B6 Grinding a flank face chamfer which adjoins the flank face facet on a first side and defines the cutting edge on a second side facing away from the flank face facet.

1. Bar blade for manufacturing a bevel gearing,
having a rake face (4),
having a flank face (6),
having a ground rake face facet (8),
having a ground flank face facet (10) and
having a cutting edge (12),
wherein the rake face (4) adjoins the rake face facet (8),wherein the flank face (6) adjoins the flank face facet (10),characterized in that
a rake face chamfer (14) is provided, which adjoins the rake face facet (8) with a first side (16) and defines the cutting edge (12) on a second side (18) facing away from the rake face facet (8),
and/or
a flank face chamfer (26) is provided, which adjoins the flank face facet (10) with a first side (28) and defines the cutting edge (12) on a second side (30) facing away from the flank face facet (10).

2. Bar blade according to claim 1,
characterized in that
the rake face chamfer (14), as viewed in a direction perpendicular to the cutting edge (12), has at least in sections a smaller width (b1) than the rake face facet (8) and/or the rake face chamfer (14) has a width (b1) of more than 50 micrometers and less than 200 micrometers, and/or the rake face chamfer (14) has a non-constant width (b1.1, b1.2, b1.2) when viewed along the cutting edge (12).

3. Bar blade according to one of the preceding claims,
characterized in that
the flank face chamfer (26), as viewed in a direction perpendicular to the cutting edge (12), has at least in sections a smaller width (b4) than the flank face facet (10) and/or the flank face chamfer (26) has a width (b4) of more than 50 micrometers and less than 200 micrometers, and/or the flank face chamfer (26) has a non-constant width (b4) along the cutting edge (12).

4. Bar blade according to one of the preceding claims,
characterized in that
an inclination of the rake face chamfer (14) relative to the rake face (4) is defined by a relative rake face chamfer inclination angle (a), wherein the rake face chamfer inclination angle (a) has a magnitude selected from a range greater than or equal to 10° and less than or equal to 30°, and/or wherein the rake face chamfer inclination angle (a), as viewed along the cutting edge (12), is not constant.

5. Bar blade according to one of the preceding claims,
characterized in that
an inclination of the flank face chamfer (26) relative to the flank face (6) is defined by a relative flank face chamfer inclination angle (c), wherein the flank face chamfer inclination angle (c) has a magnitude selected from a range greater than or equal to 10° and less than or equal to 30°, and/or wherein the flank face chamfer inclination angle (c), as viewed along the cutting edge (12), is not constant.

6. Bar blade according to one of the preceding claims,
characterized in that
the rake face chamfer (14), as viewed in cross-section, is straight at least in sections
and/or
the rake face chamfer (14), as viewed in cross-section, is concave at least in sections
and/or
the flank face chamfer (26), as viewed in cross-section, is straight at least in sections and/or the flank face chamfer (26), as viewed in cross-section, is concave at least in sections.

7. Bar blade according to one of the preceding claims,
the rake face facet (8), as viewed in cross-section, is straight at least in sections
and/or
the rake face facet (8), as viewed in cross-section, is concave at least in sections
and/or
the flank face facet (10), as viewed in cross-section, is straight at least in sections
and/or
the flank face facet (10), as viewed in cross-section, is concave at least in sections.

8. Cutter head for manufacturing a bevel gearing,
having a base body (36) that has a plurality of blade shafts (38),
having a plurality of bar blades (2, 2', 2", 2'"), wherein each of the bar blades (2, 2', 2", 2'")
is seated in an associated blade shaft (38),
characterized in that the bar blades (2, 2', 2", 2'") are designed according to one of the preceding claims.

9. Method for producing bevel gearing by machining the bevel gearing, using a cutter head according to claim 8.

10. Method for grinding a bar blade, comprising the following method steps:
grinding a rake face (4) of the bar blade (2, 2', 2", 2'"),
grinding a flank face (6) of the bar blade (2, 2', 2", 2'"),
grinding a rake face facet (8) of the bar blade (2, 2', 2", 2'"),
grinding a flank face facet (10) of the bar blade (2, 2', 2", 2'"),
wherein the rake face (4) adjoins the rake face facet (8),
wherein the flank face (6) adjoins the flank face facet (10),
characterized by
grinding a rake face chamfer (14) which adjoins the rake face facet (8) with a first side (16) and which defines the cutting edge (12) on a second side (18) facing away from the rake face facet (8),
and/or
grinding a flank face chamfer (26) which adjoins the flank face facet (10) on a first side (28) and defines the cutting edge (12) on a second side (30) facing away from the flank face facet (10).
